(19) United States
(12) Patent Application Publication
(10) Pub. No.: US 2018/0345491 A1
(43) Pub. Date: Dec. 6, 2018

(54) ROBOT TEACHING DEVICE, AND METHOD FOR GENERATING ROBOT CONTROL PROGRAM

(71) Applicant: MITSUBISHI ELECTRIC CORPORATION, Tokyo (JP)

(72) Inventor: Hideto IWAMOTO, Tokyo (JP)

(73) Assignee: MITSUBISHI ELECTRIC CORPORATION, Tokyo (JP)

(21) Appl. No.: 15/777,814

(22) PCT Filed: Jan. 29, 2016
(86) PCT No.: PCT/JP2016/052726

§ 371 Date: May 21, 2018

(51) Int. Cl. B25J 9/16; G06K 9/00

(52) U.S. Cl. CPC B25J 9/163; B25J 9/1697; G06K 9/00355

(57) ABSTRACT

Provided are a change detecting unit (12) for detecting a change in a position of a work object from an image acquired by an image input device (2), a finger motion detecting unit (13) for detecting motion of fingers of a worker from the image acquired by the image input device (2), a work content estimating unit (15) for estimating work content of the worker with respect to the work object from the motion of the fingers detected by the finger motion detecting unit (13), and a control program generating unit (16) for generating a control program of a robot (30) for reproducing the work content and conveyance of the work object from the work content estimated by the work content estimating unit (15) and the change in the position of the work object detected by the change detecting unit (12).

### TECHNICAL FIELD

The present invention relates to a robot teaching device and a method for generating a robot control program for teaching work content of a worker to a robot.

### BACKGROUND ART

In the following Patent Literature 1, a robot teaching device, which detects a three-dimensional position and direction of a worker who performs assembly work from images captured by a plurality of cameras and generates a motion program of a robot from the three-dimensional position and direction of the worker, is disclosed.

### CITATION LIST

### Patent Literature

Patent Literature 1: JP H6-250730 A (paragraphs [0010] and [0011])

### SUMMARY OF INVENTION

### Technical Problem

Since conventional robot teaching devices are configured as described above, in order to generate a motion program of a robot from the three-dimensional position and the direction of a worker performing assembly work, it is necessary that all the assembly work by the worker is photographed without omission. For this reason, there is a problem that a large number of cameras have to be installed in order to prevent a situation in which some of images of the assembly work by the worker are missing in captured images.

The present invention has been devised in order to solve the problem as described above. It is an object of the present invention to provide a robot teaching device and a method for generating a robot control program, capable of generating a control program of a robot without installing many cameras.

### Solution to Problem

A robot teaching device according to the present invention is provided with: an image input device for acquiring an image capturing fingers of a worker and a work object; a finger motion detecting unit for detecting motion of the fingers of the worker from the image acquired by the image input device; a work content estimating unit for estimating work content of the worker with respect to the work object from the motion of the fingers detected by the finger motion detecting unit; and a control program generating unit for generating a control program of a robot for reproducing the work content estimated by the work content estimating unit.

### Advantageous Effects of Invention

According to the present invention, motion of fingers of a worker is detected from an image acquired by the image input device, work content of the worker with respect to the work object is estimated from the motion of the fingers, and thereby a control program of a robot for reproducing the work content is generated. This achieves the effect of generating the control program of the robot without installing a number of cameras.

### BRIEF DESCRIPTION OF DRAWINGS

FIG. 1 is a configuration diagram illustrating a robot teaching device according to a first embodiment of the present invention.

FIG. 2 is a hardware configuration diagram of a robot controller 10 in the robot teaching device according to the first embodiment of the present invention.

FIG. 3 is a hardware configuration diagram of the robot controller 10 in a case where the robot controller 10 includes a computer.

FIG. 4 is a flowchart illustrating a method for generating a robot control program which is processing content of the robot controller 10 in the robot teaching device according to the first embodiment of the present invention.

FIG. 5 is an explanatory view illustrating a work scenery of a worker.

FIG. 6 is an explanatory diagram illustrating an image immediately before work and an image immediately after the work by a worker.

FIG. 7 is an explanatory diagram illustrating a plurality of motions of fingers of a worker recorded in a database 14.

FIG. 8 is an explanatory diagram illustrating changes in feature points when a worker is rotating a work object a.

FIG. 9 is an explanatory diagram illustrating an example of conveyance of a work object a5 in a case where a robot 30 is a horizontal articulated robot.

FIG. 10 is an explanatory diagram illustrating an example of conveyance of the work object a5 in a case where the robot 30 is a vertical articulated robot.

### DESCRIPTION OF EMBODIMENTS

To describe the present invention further in detail, embodiments for carrying out the present invention will be described below along the accompanying drawings.

### First Embodiment

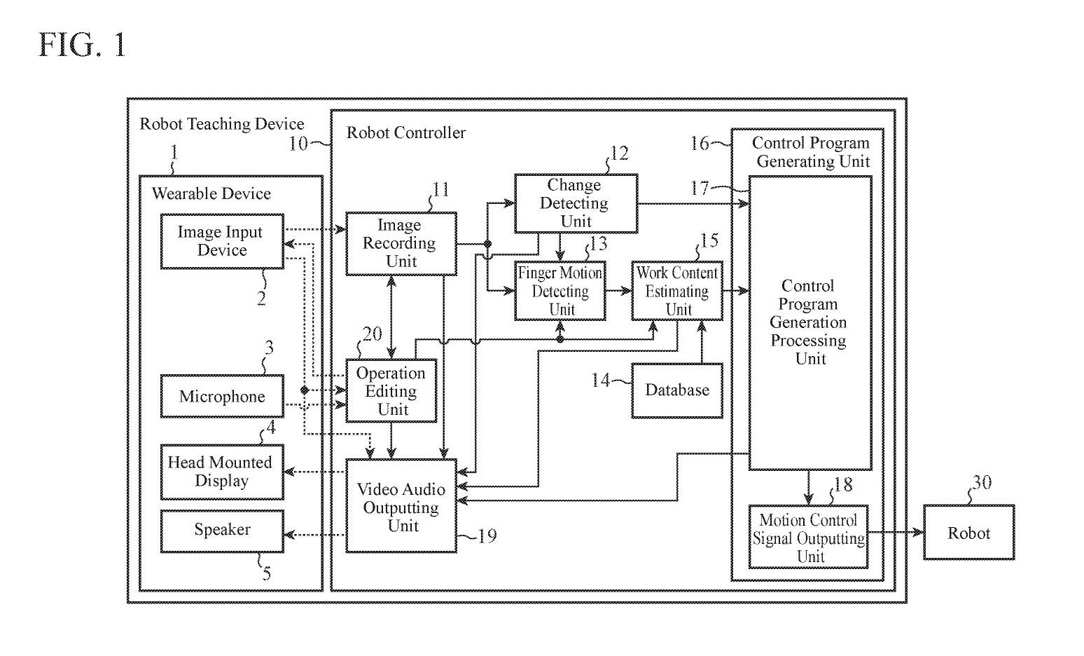

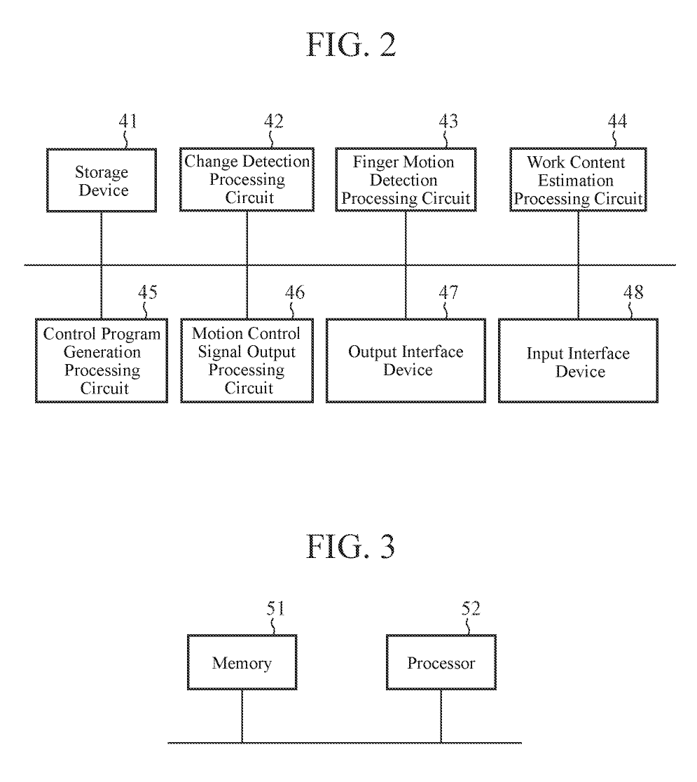

FIG. 1 is a configuration diagram illustrating a robot teaching device according to a first embodiment of the present invention. FIG. 2 is a hardware configuration diagram of a robot controller 10 in the robot teaching device according to the first embodiment of the present invention.

In FIGS. 1 and 2, a wearable device 1 is mounted on a worker and includes an image input device 2, a microphone 3, a head mounted display 4, and a speaker 5.

The image input device 2 includes one camera and acquires an image captured by the camera.

Here, the camera included in the image input device 2 is assumed to be a stereo camera capable of acquiring depth information indicating the distance to a subject in addition to two-dimensional information of the subject. Alternatively assumed is a camera in which a depth sensor capable of acquiring depth information indicating the distance to a subject is attached to a two-dimensional camera capable of acquiring two-dimensional information of the subject.

Note that as an image acquired by the image input device 2, a time-lapse moving images repeatedly photographed at predetermined sampling intervals, or still images photographed at different times, and the like are conceivable.

The robot controller 10 is a device that generates a control program of a robot 30 from an image acquired by the image input device 2 of the wearable device 1 and outputs a motion control signal of the robot 30 corresponding to the control program to the robot 30.

Note that connection between the wearable device 1 and the robot controller 10 may be wired or wireless.

An image recording unit 11 is implemented by a storage device 41 such as a random access memory (RAM) or a hard disk and records an image acquired by the image input device 2.

A change detecting unit 12 is implemented by a change detection processing circuit 42 mounted with for example a semiconductor integrated circuit mounted with a central processing unit (CPU), a one-chip microcomputer, a graphics processing unit (GPU), or the like and performs processing of detecting a change in the position of a work object from the image recorded in the image recording unit 11. That is, out of images recorded in the image recording unit 11, a difference image of an image before conveyance of the work object and an image after conveyance of the work object is obtained, and processing of detecting a change in the position of the work object from the difference image is performed.

A finger motion detecting unit 13 is implemented by a finger motion detection processing circuit 43 mounted with for example a semiconductor integrated circuit mounted with a CPU, a one-chip microcomputer, a GPU, or the like and performs processing of detecting a motion of the fingers of the worker from the image recorded in the image recording unit 11.

A database 14 is implemented by for example the storage device 41 and records, as a plurality of motions of fingers of a worker, for example, motion when a work object is rotated, motion when a work object is pushed, motion when a work object is slid, and other motions.

The database 14 further records a correspondence relation between each of motions of fingers and work content of a worker.

A work content estimating unit 15 is implemented by a work content estimation processing circuit 44 mounted with for example a semiconductor integrated circuit mounted with a CPU, a one-chip microcomputer, or the like and performs processing of estimating work content of the worker with respect to the work object from the motion of fingers detected by the finger motion detecting unit 13. That is, by collating the motion of the fingers detected by the finger motion detecting unit 13 with the plurality of motions of fingers of a worker recorded in the database 14, processing for specifying work content having a correspondence relation with the motion of the fingers detected by the finger motion detecting unit 13 is performed.

A control program generating unit 16 includes a control program generation processing unit 17 and a motion control signal outputting unit 18.

The control program generation processing unit 17 is implemented by a control program generation processing circuit 45 mounted with for example a semiconductor integrated circuit mounted with a CPU, a one-chip microcomputer, or the like and performs processing of generating a control program of the robot 30 for reproducing the work content and conveying the work object from the work content estimated by the work content estimating unit 15 and the change in the position of the work object detected by the change detecting unit 12.

The motion control signal outputting unit 18 is implemented by a motion control signal output processing circuit 46 mounted with for example a semiconductor integrated circuit mounted with a CPU, a one-chip microcomputer, or the like and performs processing of outputting a motion control signal of the robot 30 corresponding to the control program generated by the control program generation processing unit 17 to the robot 30.

A video audio outputting unit 19 is implemented by an output interface device 47 for the head mounted display 4 and the speaker 5 and an input interface device 48 for the image input device 2 and perform processing of, for example, displaying the image acquired by the image input device 2 on the head mounted display 4 and displaying information indicating that estimation processing of work content is in progress, information indicating that detection processing of a position change is in progress, or other information on the head mounted display 4.

The video audio outputting unit 19 performs processing of outputting audio data related to guidance or other information instructing work content to the speaker 5.

An operation editing unit 20 is implemented by the input interface device 48 for the image input device 2 and the microphone 3 and the output interface device 47 for the image input device 2 and performs processing of, for example, editing an image recorded in the image recording unit 11 in accordance with speech of a worker input from the microphone 3.

The robot 30 is a device that performs motion in accordance with the motion control signal output from the robot controller 10.

In the example of FIG. 1, it is assumed that each of the image recording unit 11, the change detecting unit 12, the finger motion detecting unit 13, the database 14, the work content estimating unit 15, the control program generation processing unit 17, the motion control signal outputting unit 18, the video audio outputting unit 19, and the operation editing unit 20, which is a component of the robot controller 10 in the robot teaching device, includes dedicated hardware; however, the robot controller 10 may include a computer.

FIG. 3 is a hardware configuration diagram of the robot controller 10 in a case where the robot controller 10 includes a computer.

In a case where the robot controller 10 includes a computer, it is only required that the image recording unit 11 and the database 14 are configured on a memory 51 of the computer, that a program describing the content of the processing of the change detecting unit 12, the finger motion detecting unit 13, the work content estimating unit 15, the control program generation processing unit 17, the motion control signal outputting unit 18, the video audio outputting unit 19, and the operation editing unit 20 is stored in the memory 51 of the computer, and that a processor 52 of the computer executes the program stored in the memory 51.

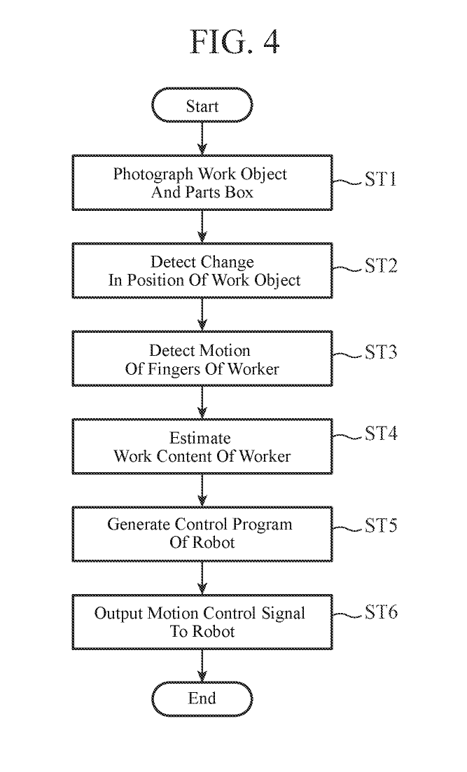

FIG. 4 is a flowchart illustrating a method for generating a robot control program which is processing content of the robot controller 10 in the robot teaching device according to the first embodiment of the present invention.

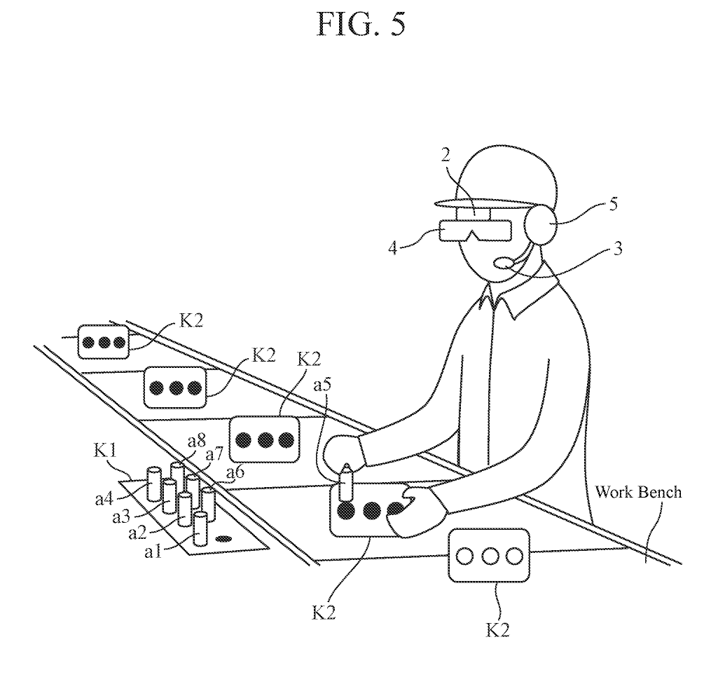

FIG. 5 is an explanatory view illustrating a work scenery of a worker.

In FIG. 5, an example is illustrated where a worker wearing the image input device 2, the microphone 3, the head mounted display 4 and the speaker 5, which are the wearable device 1, takes out a work object a5 from among cylindrical work objects a1 to a8 accommodated in a parts box K1 and pushes the work object a5 into a hole of a parts box K2 travelling on a belt conveyor which is a work bench.

Hereinafter, in a case where the work objects a1 to a8 are not distinguished, they may be referred to as work objects a.

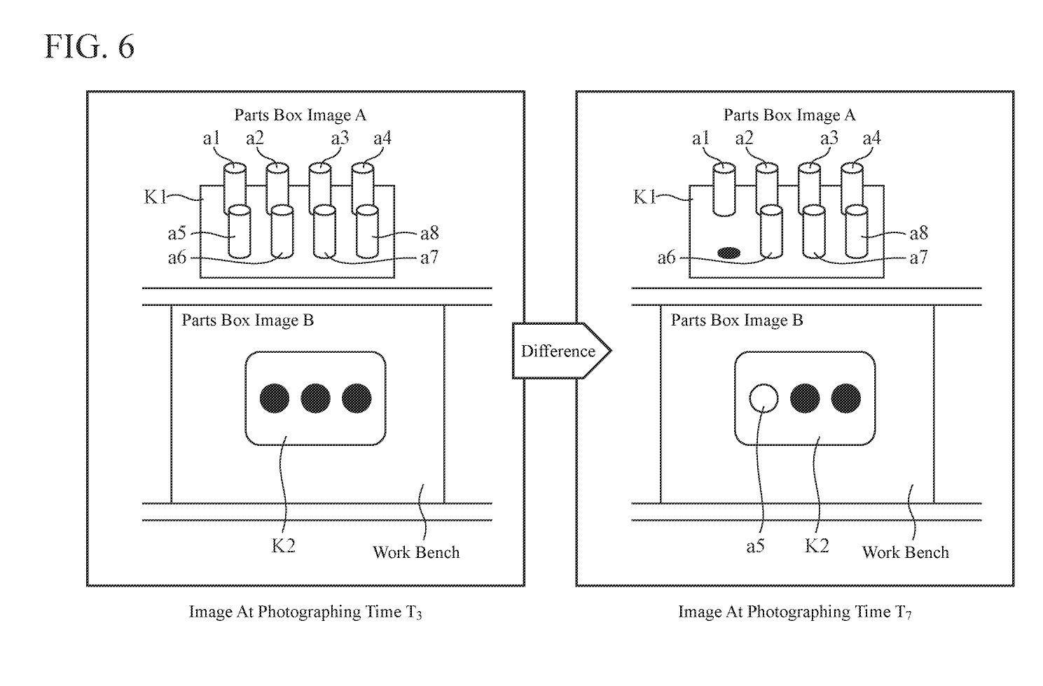

FIG. 6 is an explanatory diagram illustrating an image immediately before work and an image immediately after the work by a worker.

In the image immediately before work, the parts box K1 accommodating eight work objects a1 to a8 and the parts box K2 on the belt conveyor as a work bench are captured.

Moreover, in the image immediately after work, the parts box K1 accommodating seven work objects a1 to a4 and a6 to a8 as a result of removing the work object a5 from the parts box K1, and the parts box K2 accommodating the work object a5 are captured.

Hereinafter, the image capturing the parts box K1 is referred to as a parts box image A, and the image capturing the parts box K2 is referred to as a parts box image B.

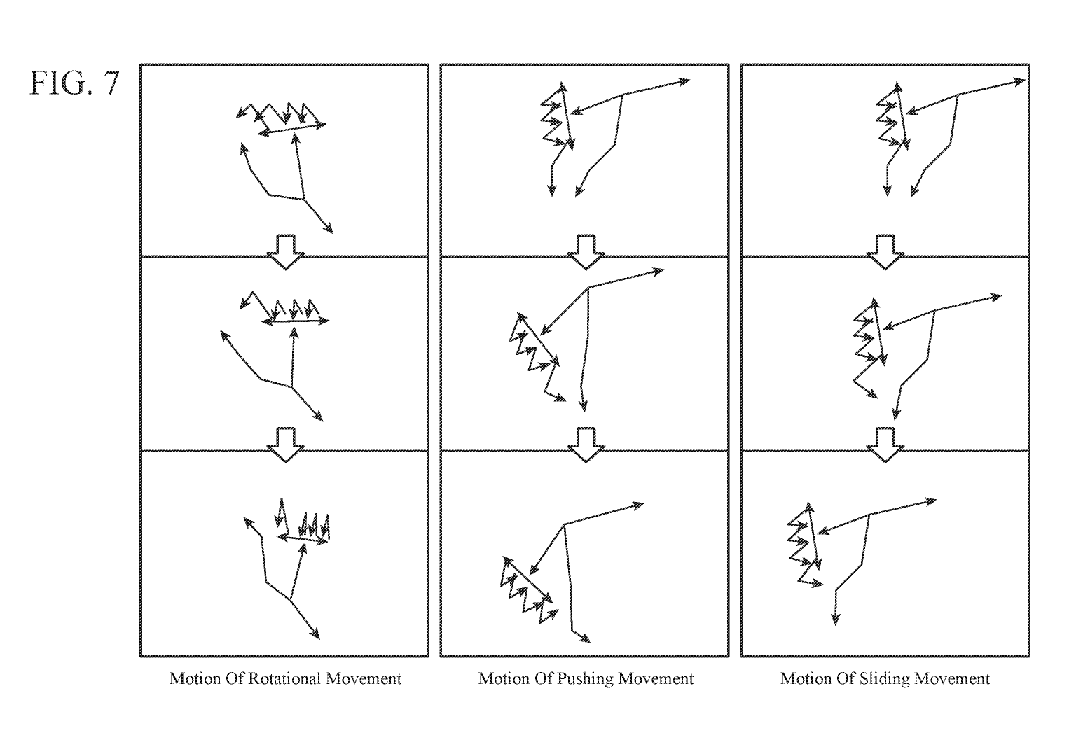

FIG. 7 is an explanatory diagram illustrating a plurality of motions of fingers of a worker recorded in the database 14.

In FIG. 7, as examples of the plurality of motions of fingers of a worker, motion of rotational movement which is motion when a work object a is rotated, motion of pushing movement which is motion when a work object a is pushed, and motion of sliding movement which is motion when the work object a is slid are illustrated.

Next, operations will be described.

The camera included in the image input device 2 of the wearable device 1 repeatedly photographs the work objects a1 to a8 and the parts boxes K1 and K2 at predetermined sampling intervals (step ST1 in FIG. 4).

The images repeatedly photographed by the camera included in the image input device 2 are recorded in the image recording unit 11 of the robot controller 10.

The change detecting unit 12 of the robot controller 10 detects a change in the position of a work object a from the images recorded in the image recording unit 11 (step ST2).

The processing of detecting the change in the position of the work object a by the change detecting unit 12 will be specifically described below.

First, the change detecting unit 12 reads a plurality of images recorded in the image recording unit 11 and extracts the parts box image A which is an image of the parts box K1 accommodating the work object a and the parts box image B which is an image of the parts box K2 from each of the images having been read, for example, by using a general image sensing technology used for detection processing of a face image applied to digital cameras.

The image sensing technology is a known technique, and thus detailed descriptions will be omitted. For example, by storing three-dimensional shapes of the parts boxes K1 and K2 and the work object a in advance and collating a three-dimensional shape of an object present in an image read from the image recording unit 11 with the three-dimensional shapes stored in advance, it is possible to discriminate whether the object present in the image is the parts box K1 or K2, the work object a, or other objects.

Upon extracting the parts box images A and B from each of the images, the change detecting unit 12 detects a plurality of feature points relating to the shape of the work objects a1 to a8 from each of the parts box images A and B and specifies three-dimensional positions of the plurality of feature points.

In the first embodiment, since it is assumed that the work objects a1 to a8 are accommodated in the parts box K1 or the parts box K2, as feature points relating to the shape of the work objects a1 to a8, for example, the center point at an upper end of the cylinder in a state where the work objects a1 to a8 are accommodated in the parts box K1 or the parts box K2 is conceivable. Feature points can also be detected by using the image sensing technology.

Upon detecting feature points relating to the shape of the work objects a1 to a8 from each of the parts box images A and B and specifying three-dimensional positions of the feature points, the change detecting unit 12 detects a change in the three-dimensional position of the feature points in the work objects a1 to a8.

Here, for example, in parts box images A at photographing time T₁, T₂, and T₃, eight work objects a1 to a8 are captured. In parts box images A at photographing time T₄, T₅, and T₆, seven work objects a1 to a4 and a6 to a8 are captured but not the work object a5, and the work object a5 is not captured in parts box images B, either. It is assumed that seven work objects a1 to a4 and a6 to a8 are captured in parts box images A at photographing time T₇, T₈, and T₉, and that one work object a5 is captured in parts box images B.

In such a case, since the seven work objects a1 to a4 and a6 to a8 are not moved, a change in the three-dimensional position of feature points in the work objects a1 to a4 and a6 to a8 is not detected.

In contrast, since the work object a5 has been moved after the photographing time T₃ before the photographing time T₇, a change in the three-dimensional position of a feature point in the work object a5 is detected.

Note that the change in the three-dimensional position of feature points in the work objects a1 to a8 can be detected by obtaining a difference between parts box images A or a difference between parts box images B at different photographing time T. That is, in a case where there is no change in the three-dimensional position of a feature point in a work object a, the work object a does not appear in a difference image. However, in a case where there is a change in the three-dimensional position of the feature point in the work object a, the object a appears in the difference image, and thus presence or absence of a change in the three-dimensional position of the feature point in the work object a can be discriminated on the basis of presence or absence of the work object a in the difference image.

Upon detecting the change in the three-dimensional position of the feature point in the work object a, the change detecting unit 12 specifies the photographing time T immediately before the change and the photographing time T immediately after the change.

In the above example, the photographing time T₃ is specified as the photographing time T immediately before the change, and the photographing time T₇ is specified as the photographing time T immediately after the change.

In FIG. 6, the parts box images A and B at the photographing time T₃ and the parts box images A and B at the photographing time T₇ are illustrated.

The change detecting unit 12 detects a change in the three-dimensional position of the feature point in the work object a5, specifies the photographing time T₃ as the photographing time T immediately before the change, and specifies the photographing time T₇ as the photographing time T immediately after the change, then, from the three-dimensional position of the feature point in the work object a5 in the parts box image A at the photographing time T₃ and the three-dimensional position of the feature point in the work object a5 in the parts box image B at the photographing time T₇, calculates movement data M indicating a change in the position of the work object a5.

For example, assuming that the three-dimensional position of the feature point in the work object a5 in the parts box image A at the photographing time T₃ is (x₁, y₁, z₁) and that the three-dimensional position of the feature point in the work object a5 in the parts box image B at the photographing time T₇ is (x₂, y₂, z₂), an amount of movement ΔM of the work object a5 is calculated as expressed in the following mathematical formula (1).

ΔM=(ΔMₓ,ΔM_{y},ΔM_{z})

ΔMₓ=x₂−x₁

ΔM_{y}=y₂−y₁

ΔM_{z}=z₂−z₁ (1)

The change detecting unit 12 outputs movement data M including the amount of movement ΔM of the work object a5, the three-dimensional position before the movement (x₁, y₁, z₁), and the three-dimensional position after the movement (x₂, y₂, z₂) to the control program generation processing unit 17.

The finger motion detecting unit 13 of the robot controller 10 detects motion of the fingers of the worker from the image recorded in the image recording unit 11 (step ST3).

The detection processing of motion of fingers by the finger motion detecting unit 13 will be specifically described below.

The finger motion detecting unit 13 reads a series of images from an image immediately before a change through to an image immediately after the change from among the plurality of images recorded in the image recording unit 11.

In the above example, since the change detecting unit 12 specifies the photographing time T₃ as the photographing time T immediately before the change and specifies the photographing time T₇ as the photographing time T immediately after the change, the image at the photographing time T₃, the image at the photographing time T₄, the image at the photographing time T₅, the image at the photographing time T₆, and the image at the photographing time T₇ are read from among the plurality of images recorded in the image recording unit 11.

Upon reading the images at the photographing time T₃ to T₇, the finger motion detecting unit 13 detects a part capturing the fingers of the worker from each of the images having been read, for example, by using the image sensing technique and extracts images of the parts capturing the fingers of the worker (hereinafter referred to as “fingers image”).

The image sensing technology is a known technique, and thus detailed descriptions will be omitted. For example, by registering the three-dimensional shape of human fingers in advance in memory and collating the three-dimensional shape of an object present in the image read from the image recording unit 11 with the three-dimensional shape stored in advance, it is possible to discriminate whether the object present in the image is the fingers of the worker.

Upon separately extracting the fingers image from each of the images, the finger motion detecting unit 13 detects motion of the fingers of the worker from the fingers images separately extracted by using, for example, a motion capture technique.

The motion capture technique is a known technique disclosed also in the following Patent Literature 2, and thus detailed descriptions will be omitted. For example, by detecting a plurality of feature points relating to the shape of human fingers and tracking changes in the three-dimensional positions of the plurality of feature points, it is possible to detect the motion of the fingers of the worker.

As feature points relating to the shape of human fingers, finger joints, fingertips, finger bases, a wrist, or the like are conceivable.

Patent Literature 2: JP 2007-121217 A

In the first embodiment, it is assumed that the motion of the fingers of the worker is detected by detecting a plurality of feature points relating to the shape of human fingers by image processing on the plurality of fingers images and tracking changes in the three-dimensional positions of the plurality of feature points; however, for example in a case where a glove with markers is worn on fingers of a worker, motion of the fingers of the worker may be detected by detecting the positions of the markers captured in the plurality of fingers images and tracking changes in the three-dimensional positions of the plurality of markers.

Alternatively, in a case where a glove with force sensors is worn on fingers of a worker, motion of the fingers of the worker may be detected by tracking a change in sensor signals of the force sensors.

In the first embodiment, it is assumed that motion of rotational movement which is motion when the work object a is rotated, motion of pushing movement which is motion when the work object a is pushed, and motion of sliding movement which is motion when the work object a is slid are detected; however, motions to be detected are not limited to these motions, and other motions may be detected.

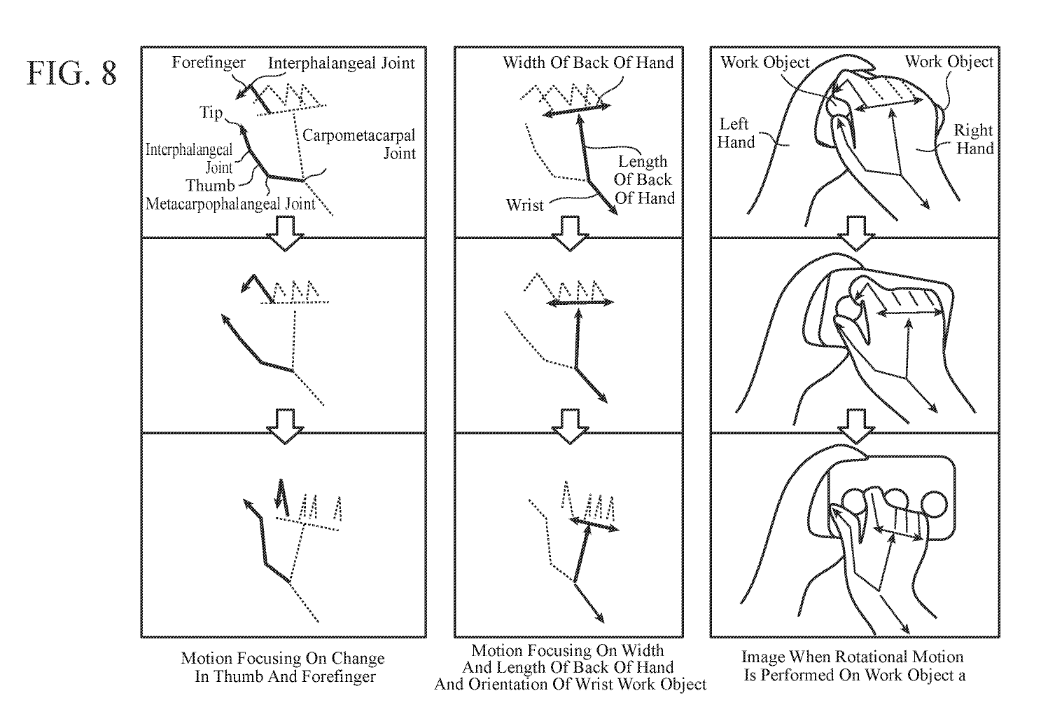

Here, FIG. 8 is an explanatory diagram illustrating changes in feature points when a worker is rotating a work object a.

In FIG. 8, an arrow represents a link connecting a plurality of feature points, and for example observing a change in a link connecting a feature point of the carpometacarpal joint of the thumb, a feature point of the metacarpophalangeal joint of the thumb, a feature point of the interphalangeal joint of the thumb, and a feature point of the tip of the thumb allows for confirming a change in the motion of the thumb.

Conceivably, the motion of rotational movement, for example, includes motion of rotating a forefinger clockwise, wherein a portion ranging from the interphalangeal joint to the base of the forefinger is substantially parallel to the thumb with the interphalangeal joint bended while the extended thumb is rotated clockwise.

Note that in FIG. 8, motion focusing on changes in the thumb and the forefinger and motion focusing on the width and the length of the back of a hand and orientation of a wrist are illustrated.

When the finger motion detecting unit 13 detects the motion of the fingers of the worker, the work content estimating unit 15 of the robot controller 10 estimates work content of the worker with respect to the work object a from the motion of the fingers (step ST4).

That is, the work content estimating unit 15 collates the motion of the fingers detected by the finger motion detecting unit 13 with the plurality of motions of fingers of a worker recorded in the database 14 and thereby specifies work content having a correspondence relation with the motion of the fingers detected by the finger motion detecting unit 13.

In the example of FIG. 7, since the motion of rotational movement, the motion of pushing movement, and the motion of sliding movement are recorded in the database 14, the motion of the fingers detected by the finger motion detecting unit 13 is collated with the motion of rotational movement, the motion of pushing movement, and motion of sliding movement recorded in the database 14.

As a result of collation, for example if the degree of agreement of the motion of rotational movement is the highest among the motion of the rotational movement, the motion of pushing movement, and the motion of sliding movement, it is estimated that work content of the worker is the motion of rotational movement.

Alternatively, if the degree of agreement of the motion of pushing movement is the highest, work content of the worker is estimated to be the motion of pushing movement. If the degree of agreement of the motion of sliding movement is the highest, work content of the worker is estimated to be the motion of sliding movement.

In the work content estimating unit 15, even if the motion of the fingers detected by the finger motion detecting unit 13 does not completely match the motion of fingers of a worker recorded in the database 14, it is estimated that motion having a relatively high degree of agreement among motions of the fingers of the worker recorded in the database 14 is the work content of the worker, and thus even in a case where a part of the fingers of the worker is hidden behind the palm or other objects and is not captured in an image, the work content of the worker can be estimated. Therefore, even with a small number of cameras, work content of the worker can be estimated.

Here, for the sake of simplicity of explanation, an example in which each one of the motion of rotational movement, the motion of pushing movement, and the motion of sliding movement is recorded in the database 14 is illustrated; however, actually, even for the same rotational movement, for example, motions of a plurality of rotational movements having different rotation angles are recorded in the database 14. Moreover, even for the same pushing movement, for example, motions of a plurality of pushing movements having different pushing amounts are recorded in the database 14. Even for the same sliding movement, for example, the actions of a plurality of sliding movements having different sliding amounts are recorded in the database 14.

Therefore, it is estimated not only that work content of the worker is, for example, motion of rotational movement but also that the motion of the rotational movement has a rotation angle of 60 degrees, for example.

The control program generation processing unit 17 of the robot controller 10 generates a control program of the robot 30 for reproducing the work content and conveying the work object a from the work content estimated by the work content estimating unit 15 and the change in the position of the work object a detected by the change detecting unit 12 (step ST5).

That is, the control program generation processing unit 17 generates, from the movement data M output from the change detecting unit 12, a control program P1 for moving the work object a5 at the three-dimensional position (x₁, y₁, z₁) accommodated in the parts box K1 to the three-dimensional position (x₂, y₂, z₂) of the parts box K2.

At this time, a control program P1 that allows a travel route from the three-dimensional position (x₁, y₁, z₁) to the three-dimensional position (x₂, y₂, z₂) to be the shortest is conceivable; however, in a case where another work object a or other objects are present in the conveyance path, a control program P1 that gives a route detouring the other work object a or the other objects is generated.

Therefore, various routes can be conceivable as the travel route from the three-dimensional position (x₁, y₁, z₁) to the three-dimensional position (x₂, y₂, z₂), it is only required to be determined as appropriate, for example, by using a route search technique of a car navigation device with consideration given to the direction in which an arm of the robot 30 can move on the basis of the degree of freedom of joints of the robot 30.

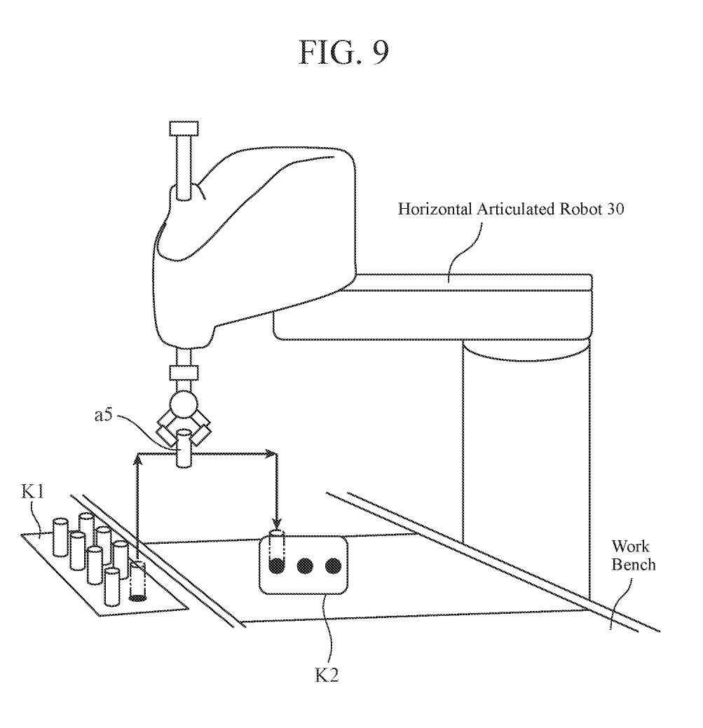

FIG. 9 is an explanatory diagram illustrating an example of conveyance of a work object a5 in a case where the robot 30 is a horizontal articulated robot.

In the case where the robot 30 is a horizontal articulated robot, a control program P1 for lifting straight up the work object a5 present at the three-dimensional position (x₁, y₁, z₁) and moving in a horizontal direction and then bringing down the work object a5 to the three-dimensional position (x₂, y₂, z₂) is generated.

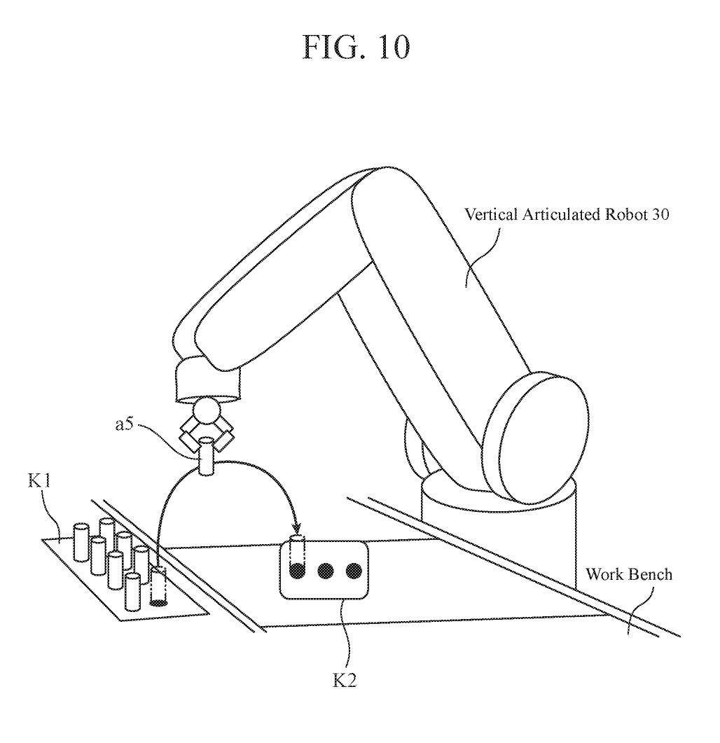

FIG. 10 is an explanatory diagram illustrating an example of conveyance of the work object a5 in a case where the robot 30 is a vertical articulated robot.

In the case where the robot 30 is a vertical articulated robot, a control program P1 for lifting straight up the work object a5 present at the three-dimensional position (x₁, y₁, z₁) and moving so as to draw a parabola and then bringing down the work object a5 to the three-dimensional position (x₂, y₂, z₂) is generated.

Next, the control program generation processing unit 17 generates a control program P2 of the robot 30 for reproducing the work content estimated by the work content estimating unit 15.

For example, if the work content estimated by the work content estimating unit 15 is motion of rotational movement having a rotation angle of 90 degrees, a control program P2 for rotating the work object a by 90 degrees is generated. If the work content is motion of pushing movement having a pushing amount of 3 cm, a control program P2 for pushing the work object a by 3 cm is generated. If the work content is motion of sliding movement having a slide amount of 5 cm, a control program P2 for sliding the work object a by 5 cm is generated.

Note that in the examples of FIG. 5, FIG. 9, and FIG. 10, as work content, motion of pushing the work object a5 into a hole in the parts box K2 is assumed.

In the first embodiment, exemplary work in which the work object a5 accommodated in the parts box K1 is conveyed and then the work object a5 is pushed into the hole in the parts box K2 is illustrated; however, without being limited to thereto, work may be, for example, rotating the work object a5 accommodated in the parts box K1 without conveying the work object a5 accommodated in the parts box K1, or further pushing the work object a. In the case of such work, only a control program P2 for reproducing work content estimated by the work content estimating unit 15 is generated without generating a control program P1 for conveying the work object a5.

When the control program generation processing unit 17 generates a control program, the motion control signal outputting unit 18 of the robot controller 10 outputs a motion control signal of the robot 30 corresponding to the control program to the robot 30 (step ST6).

For example in a case where the work object a is rotated, since the motion control signal outputting unit 18 stores which joint to move from among a plurality of joints included the robot 30 and also a correspondence relation between the rotation amount of the work object a and the rotation amount of a motor for moving the joint, the motion control signal outputting unit 18 generates a motion control signal indicating information specifying a motor connected to the joint to be moved and the rotation amount of the motor corresponding to the rotation amount of the work object a indicated by the control program and outputs the motion control signal to the robot 30.

For example in a case where the work object a is pushed, since the motion control signal outputting unit 18 stores which joint to move from among a plurality of joints the robot 30 has and also a correspondence relation between the pushing amount of the work object a and the rotation amount of a motor for moving the joint, the motion control signal outputting unit 18 generates a motion control signal indicating information specifying a motor connected to the joint to be moved and the rotation amount of the motor corresponding to the pushing amount of the work object a indicated by the control program and outputs the motion control signal to the robot 30.

For example in a case where the work object a is slid, since the motion control signal outputting unit 18 stores which joint to move from among a plurality of joints the robot 30 has and also a correspondence relation between the sliding amount of the work object a and the rotation amount of a motor for moving the joint, the motion control signal outputting unit 18 generates a motion control signal indicating information specifying a motor connected to the joint to be moved and the rotation amount of the motor corresponding to the sliding amount of the work object a indicated by the control program and outputs the motion control signal to the robot 30.

Upon receiving the motion control signal from the motion control signal outputting unit 18, the robot 30 rotates the motor indicated by the motion control signal by the rotation amount indicated by the motion control signal, thereby performing work on the work object a.

Here, the worker wears the head mounted display 4, and in a case where the head mounted display 4 is an optical see-through type in which the outside world can be seen through, even when the head mounted display 4 is worn, the parts box K1 or K2 or the work object is visible through glass.

Alternatively, in a case where the head mounted display 4 is a video type, since the parts box K1 or K2 or the work object a is not directly visible, the worker is allowed to confirm the parts box K1 or K2 or the work object a by causing the video audio outputting unit 19 to display the image acquired by the image input device 2 on the head mounted display 4.

When the change detecting unit 12 is performing processing of detecting a change in the position of a work object, the video audio outputting unit 19 displays information indicating that processing of detecting a change in the position is in progress on the head mounted display 4. Moreover, when the work content estimating unit 15 is performing processing of estimating work content of a worker, the video audio outputting unit 19 displays information indicating that processing of estimating work content is in progress on the head mounted display 4.

By viewing display content of the head mounted display 4, the worker can recognize that a control program of the robot 30 is currently being generated.

Furthermore, for example, in a case where a guidance for instructing work content is registered in advance or a guidance is given from outside, the video audio outputting unit 19 outputs audio data relating to the guidance to the speaker 5.

As a result, the worker can surely grasp the work content and smoothly perform the correct work.

The worker can operate the robot controller 10 through the microphone 3.

That is, when the worker utters operation content of the robot controller 10, the operation editing unit 20 analyzes the speech of the worker input from the microphone 3 and recognizes the operation content of the robot controller 10.

Moreover, when the worker performs a gesture corresponding to operation content of the robot controller 10, the operation editing unit 20 analyzes the image acquired by the image input device 2 and recognizes the operation content of the robot controller 10.

As the operation content of the robot controller 10, reproduction operation for displaying images capturing the parts box K1 or K2 or the work object a again on the head mounted display 4, operation for designating a part of work in a series of pieces of work captured in an image being reproduced and requesting redoing of the part of the work, and other operations are conceivable.

Upon receiving reproduction operation of the image capturing the parts box K1 or K2 or the work object a, the operation editing unit 20 reads the image recorded in the image recording unit 11 and displays the image to the head mounted display 4.

Alternatively, upon receiving operation requesting redoing of a part of work, the operation editing unit 20 causes the speaker 5 to output an announcement prompting redoing of the part of the work and also outputs an instruction to acquire an image to the image input device 2.

When the worker redoes the part of the work, the operation editing unit 20 performs image editing of inserting an image capturing the part of the work acquired by the image input device 2 in an image recorded in the image recording unit 11.

As a result, the image recorded in the image recording unit 11 is modified to an image in which the part of the work is redone out of the series of pieces of work.

When editing of the image is completed, the operation editing unit 20 outputs an instruction to acquire the edited image from the image recording unit 11 to the change detecting unit 12 and the finger motion detecting unit 13.

As a result, the processing of the change detecting unit 12 and the finger motion detecting unit 13 is started, and finally a motion control signal of the robot 30 is generated on the basis of the edited image, and the motion control signal is output to the robot 30.

As is apparent from the above, according to the first embodiment, there are provided the finger motion detecting unit 13 for detecting motion of the fingers of the worker from the image acquired by the image input device 2 and the work content estimating unit 15 for estimating work content of the worker with respect to the work object a from the motion of the fingers detected by the finger motion detecting unit 13, and the control program generating unit 16 generates the control program of the robot 30 for reproducing the work content estimated by the work content estimating unit 15, thereby achieving an effect that a control program of the robot 30 can be generated without installing a large number of cameras.

That is, in the work content estimating unit 15, even if the motion of the fingers detected by the finger motion detecting unit 13 does not completely match the motion of fingers of a worker recorded in the database 14, it is estimated that motion having a relatively high degree of agreement than other motions is the work content of the worker, and thus even in a case where a part of the fingers of the worker is hidden behind the palm or other objects and is not captured in an image, the work content of the worker can be estimated. Therefore, it is possible to generate a control program of the robot 30 without installing a number of cameras.

Further, according to the first embodiment, there is included the change detecting unit 12 for detecting a change in the position of the work object a from the image acquired by the image input device 2, and the control program generating unit 16 generates the control program of the robot for reproducing the work content and conveying the work object a from the work content estimated by the work content estimating unit 15 and the change in the position of the work object detected by the change detecting unit 12, thereby achieving an effect that a control program of the robot 30 is generated even when the work object a is conveyed.

Furthermore, according to the first embodiment, the image input device 2 mounted on the wearable device 1 is used as the image input device, thereby achieving an effect that a control program of the robot 30 can be generated without installing a fixed camera near the work bench.

Incidentally, within the scope of the present invention, the present invention may include a modification of any component of the embodiments, or an omission of any component in the embodiments.

### INDUSTRIAL APPLICABILITY

A robot teaching device and a method for generating a robot control program according to the present invention are suitable for those required to reduce the number of cameras to be installed when work content of a worker is taught to a robot.

### REFERENCE SIGNS LIST

1: Wearable device, 2: Image input device, 3: Microphone, 4: Head mounted display, 5: Speaker, 10: Robot controller, 11: Image recording unit, 12: Change detecting unit, 13: Finger motion detecting unit, 14: Database, 15: Work content estimating unit, 16: Control program generating unit, 17: Control program generation processing unit, 18: Motion control signal outputting unit, 19: Video audio outputting unit, 20: Operation editing unit, 30: Robot, 41: Storage device, 42: Change detection processing circuit, 43: Finger motion detection processing circuit, 44: Work content estimation processing circuit, 45: Control program generation processing circuit, 46: Motion control signal output processing circuit, 47: Output interface device, 48: Input interface device, 51: Memory, 52: Processor, a1 to a8: Work object, K1, K2: Parts box

1-10. (canceled)

11. A robot teaching device comprising:
an image input device to acquire an image capturing fingers of a worker and a work object;
a processor; and
a memory storing instructions which, when executed by the processor, causes the processor to perform processes of:
detecting a series of motions of the fingers of the worker from the image acquired by the image input device;
estimating work content of the worker with respect to the work object from the series of motions of the fingers detected;
generating a control program of a robot for reproducing the estimated work content; and
database to record a plurality of series of motions of fingers of a worker and a correspondence relation between each of the series of motions of the fingers and the work content of the worker,
wherein the processor collates the series of motions of the fingers detected with the plurality of series of motions of the fingers of the worker recorded in the database and specifies work content having a correspondence relation with the series of motions of the fingers detected.

12. The robot teaching device according to claim 11,
wherein the processes further include:
detecting a change in a position of the work object from the image acquired by the image input device,
wherein the processor generates the control program of the robot for reproducing the work content and conveying the work object from the estimated work content and the change in the position of the detected work object.

13. The robot teaching device according to claim 12,
wherein the processor detects the change in the position of the work object from a difference image of an image before conveyance of the work object and an image after conveyance of the work object out of images acquired by age input device.

14. The robot teaching device according to claim 11,
wherein the processor outputs a motion control signal of the robot corresponding to the control program of the robot to the robot.

15. The robot teaching device according to claim 11,
wherein, as the image input device, an image input device mounted on a wearable device is used.

16. The robot teaching device according to claim 15,
wherein the wearable device includes a head mounted display.

17. The robot teaching device according to claim 11,
wherein the image input device includes one camera and acquires an image captured by the camera.

18. The robot teaching device according to claim 11,
wherein the image input device includes a stereo camera and acquires an image captured by the stereo camera.

19. A method for generating a robot control program, comprising:
acquiring, by an image input device, an image capturing fingers of a worker and a work object;
detecting, by a finger motion detector, a series of motions of the fingers of the worker from the image acquired by the image input device;
estimating, by a work content estimator, work content of the worker with respect to the work object from the series of motions of the fingers detected by the finger motion detector; and
generating, by a control program generator, a control program of a robot for reproducing the work content from the work content estimated by the work content estimator.
